(19) United States
(12) Patent Application Publication
(10) Pub. No.: US 2016/0227174 A1
(43) Pub. Date: Aug. 4, 2016

(54) COMMUNICATION DEVICE

(71) Applicant: CANON KABUSHIKI KAISHA, Tokyo (JP)

(72) Inventor: Kazuhide Mori, Yokohama-shi (JP)

(21) Appl. No.: 15/006,986

(22) Filed: Jan. 26, 2016

(30) Foreign Application Priority Data
Jan. 30, 2015 (JP) 2015-017711

(51) Int. Cl. H04N 7/18; G06K 9/00; H04N 5/232

(52) U.S. Cl. CPC H04N 7/183; H04N 5/23206; G06K 9/00771; G06K 9/00369

(57) ABSTRACT

A communication device includes a delivery unit that delivers data including an image, a receiving unit that receives a control command, a control unit that controls an operation of the communication device, an authentication unit for performing user authentication, a storing unit, a restriction unit that restricts an operation of the control command based on an authentication result of the authentication unit, and a first initialization unit and a second initialization unit for updating setting information to initial values that are stored by the storing unit. The first initialization unit updates all the setting information including the user information to initial values that are stored by the storing unit. The second initialization unit does not update at least the setting information related to the user information to initial values that are stored by the storing unit.

### BACKGROUND OF THE INVENTION

1. Field of the Invention

The present invention relates to a communication device, for example, a communication device including a means to initialize setting information.

2. Description of the Related Art

In recent years, along with diversification and complication of setting information of a communication device, a technique to reset the setting information to return to a factory shipment state, that is, an initial state is known. For example, Japanese Patent Application Laid-Open No. 8-23548 discloses an image capturing device having a function to be able to return setting information to a factory shipment state.

Further, as an example of a communication device, there is an ONVIF (Open Network Video Interface Forum) standard which is one of communication standards on a network in an image capturing device. Here, a command group for network-connecting the image capturing device and performing video streaming and control is implemented.

However, the setting information includes information related to an administrator user. In this case, if all the setting information is reset to a factory shipment state, the information related to an administrator user is also reset, so that a user password and the like have to be set again and this is troublesome. Further, no administrator user is set, so that there is a trouble that the security of the device itself degrades.

In view of the above problems, an object of the present invention is to enable a user to perform an appropriate device operation without forcing the user to perform complicated work when updating setting information to values set at the time of factory shipment.

### SUMMARY OF THE INVENTION

To solve the above problems, the communication device of the present invention is a communication device including a communication unit that communicates data including at least an image with an external device through a network. The communication device includes a delivery unit that delivers data including the image, a receiving unit that receives a control command to set setting information for controlling the communication device, a control unit that controls an operation of the communication device based on content of the setting information, an authentication unit for performing user authentication in communication with the external device, a storing unit for storing user information used for the authentication unit and initial values of the setting information, a restriction unit that restricts an operation of the control command based on an authentication result of the authentication unit, and a first initialization unit and a second initialization unit for updating the setting information to initial values that are stored by the storing unit. The first initialization unit updates all the setting information including the user information to initial values that are stored by the storing unit. The second initialization unit does not update at least the setting information related to the user information to initial values that are stored by the storing unit.

Further features of the present invention will become apparent from the following description of exemplary embodiments (with reference to the attached drawings).

### BRIEF DESCRIPTION OF THE DRAWINGS

FIGS. 1A and 1B are network configuration diagrams including a configuration of an image capturing device of the present embodiment.

FIG. 2 is a block diagram in the image capturing device of the present embodiment.

FIG. 3 is a block diagram showing an internal configuration of a client device of the present embodiment.

FIG. 4 is an example of a command sequence diagram.

FIGS. 5A and 5B are examples of a command sequence diagram.

FIGS. 6A and 6B are diagrams showing a state of the image capturing device of the present embodiment.

FIGS. 7A to 7C are diagrams showing a definition example of a User type of the present embodiment.

FIGS. 8A and 8B are diagrams showing a definition example of a Scope type of the present embodiment.

FIG. 9 is a diagram showing a definition example of FactoryDefaultType of the present embodiment.

FIG. 10 is a flowchart when receiving SetSystemFactoryDefault.

### DESCRIPTION OF THE EMBODIMENTS

Hereinafter, an embodiment of the present invention will be described in detail with reference to the drawings. Hereinafter, a preferred embodiment of the present invention will be described in detail with reference to the accompanying drawings.

A configuration shown in the embodiment below is only an example, and the present invention is not limited to the configuration shown in the drawings. The commands in the embodiment described below are defined based on, for example, Open Network Video Interface Forum standard.

### First Embodiment

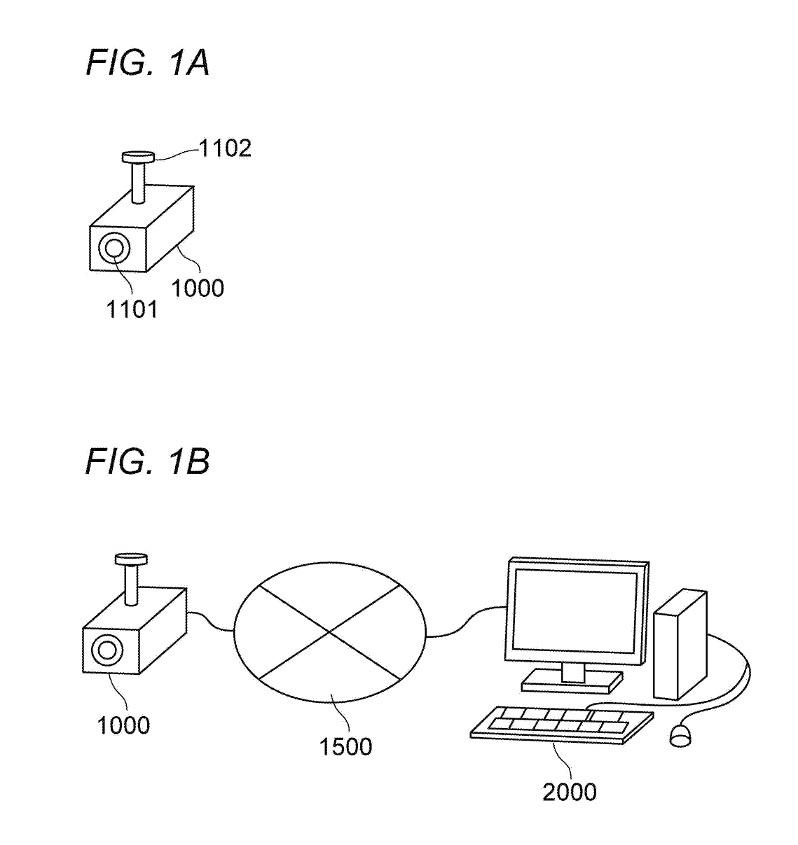

Hereinafter, a network configuration according to the present embodiment will be described with reference to FIGS. 1A and 1B.

Reference numeral 1000 in FIG. 1A denotes a figure showing an image capturing device which is an embodiment of the present invention. Reference numeral 1101 denotes a housing including a lens. Reference numeral 1102 denotes an arm mechanism that can determine a direction according to an installation location and a photographing field angle when the image capturing device is suspended from a ceiling and installed in a pan direction and a tilt direction.

FIG. 1B is a system configuration diagram including the image capturing device 1000. Reference numeral 2000 denotes a client device that represents an external apparatus in the present invention. The image capturing device 1000 and the client device 2000 are connected to each other in a communicable state through an IP network 1500. The client device 2000 transmits various commands such as an image capturing parameter change, a video streaming start, and the like, which are described later, to the image capturing device 1000. The image capturing device 1000 transmits responses to these commands and a video streaming to the client device 2000.

The image capturing device 1000 of the present embodiment is an example of a communication device that communicates with an external device through a network. For example, the image capturing device 1000 is a monitoring camera that captures a moving image. More specifically, the image capturing device 1000 is a network camera used for monitoring. The client device 2000 of the present embodiment is an example of an external device such as a PC. A monitoring system of the present embodiment corresponds to an image capturing system.

The IP network 1500 includes a plurality of routers, switches, and cables, which satisfy a communication standard such as, for example, Ethernet (registered trademark). However, in the present embodiment, if the IP network 1500 can cause the image capturing device 1000 and the client device 2000 to communicate with each other, the communication standard, the scale, and the configuration of the IP network 1500 do not matter.

For example, the IP network 1500 may be composed of the Internet, a wired LAN (Local Area Network), a wireless LAN, a WAN (Wide Area Network), and the like. The image capturing device 1000 of the present embodiment may be compatible with PoE (Power Over Ethernet (registered trademark)) and may be supplied with power through a LAN cable.

The client device 2000 of the present embodiment is an example of an external device such as a PC. The monitoring system of the present embodiment corresponds to an image capturing system.

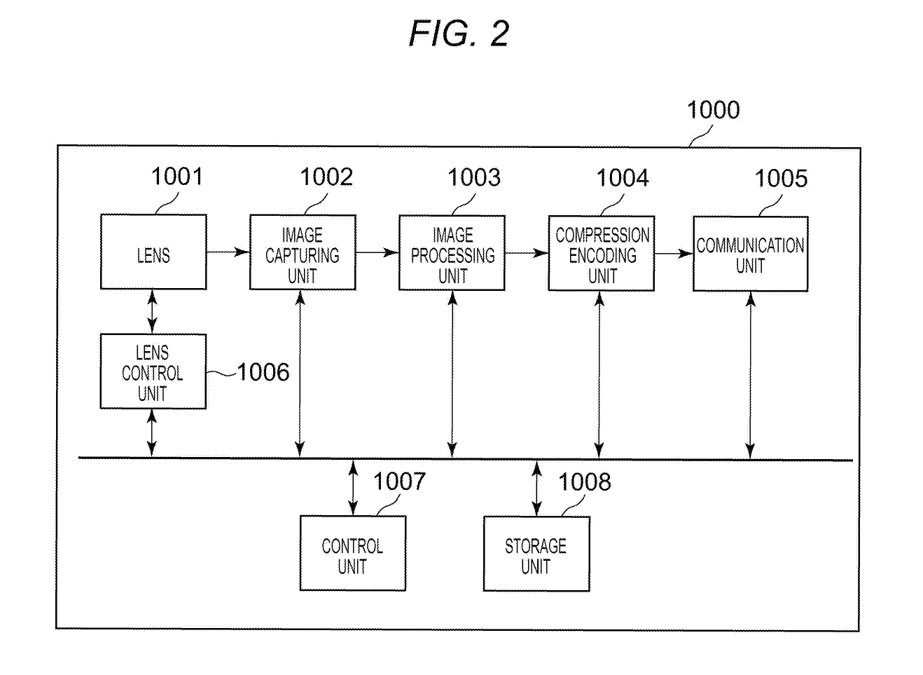

FIG. 2 is a block diagram showing an internal configuration of the image capturing device 1000 of the present embodiment. In FIG. 2, reference numeral 1001 denotes a lens, reference numeral 1002 denotes an image capturing unit, reference numeral 1003 denotes an image processing unit, reference numeral 1004 denotes a compression encoding unit, reference numeral 1005 denotes a communication unit, reference numeral 1006 denotes a lens control unit, reference numeral 1007 denotes a control unit, and reference numeral 1008 denotes a storage unit.

Next, an operation of the image capturing device according to the present embodiment will be described with reference to FIG. 2. A light beam from a subject whose image will be captured is input through the lens 1001 and, is formed into an image in the image capturing unit 1002, and is output as a video signal where an image of the subject is captured. Regarding the lens 1001, control processing on an input video signal is performed, such as changing the aperture of the lens 1001 according to the image of the subject input by the lens control unit 1006, adjusting a focus position to bring the image into focus, and inserting and removing an infrared cut filter. The video signal captured by the image capturing unit 1002 is input into the image processing unit 1003.

In FIG. 2, the communication unit 1005 receives an instruction of video size setting from the client device 2000 and a control command including a setting command related to exposure control such as white balance and gain for the subject image. The setting command for the image is analyzed by the control unit 1007 and is input into the image processing unit 1003. At the same time, image setting information is stored in the storage unit 1008, and setting is done on the image processing unit 1003 from the control unit 1007 according to the image setting information stored in the storage unit 1008 at the time of start-up. The image processing unit 1003 performs image processing according to the image setting information and inputs the processed image into the compression encoding unit 1004.

In FIG. 2, the communication unit 1005 receives a control command including an encoding setting command from the client device 2000. The encoding setting command is analyzed by the control unit 1007, stored in the storage unit 1008, and thereafter input into the compression encoding unit 1004. The encoding setting information includes specification information related to such as, for example, an encoding method, an image size, rotation of image, and a resolution of the image. The compression encoding unit 1004 compresses and encodes an input subject image in the image processing unit 1003 to a plurality of specified image sizes or resolutions of the image by the specified encoding method.

By the operation as described above, the image capturing device 1000 of the present embodiment can deliver image streams of different image sizes by different encoding methods in the same scene at substantially the same time. The image streams are output to the outside through the communication unit 1005.

Further, in FIG. 2, the communication unit 1005 receives a control command including a factory shipment setting command from the client device 2000. The factory shipment setting command is received by the communication unit 1005 and thereafter analyzed by the control unit 1007 and updates various setting information stored in the storage unit 1008 by using the factory shipment settings stored in the storage unit 1008. For example, the image setting information and the encoding setting information described above are updated to the factory shipment settings.

The control unit 1007 includes a CPU, integrally controls each constituent element of the client device 2000, and sets various parameters and the like. The storage unit 1008 includes a memory or the like where data can be electrically erased, and the control unit 1007 executes a program stored in the storage unit 1008. The memory is used as a storage area of the program executed by the control unit 1007, a work area used when the program is being executed, a storage area of data, and the like. In addition, the storage unit 1008 stores initial values of various parameters which are setting information used by the control unit 1007 to control the image capturing device 1000. The stored initial values are used by an initialization command and the like. Specifically, the image capturing device 1000 that receives the initialization command updates the setting information including information, which is set from the client device 2000 and the like after the image capturing device 1000 is installed and an operation of the image capturing device 1000 is started, by the initial values stored in the storage unit 1008.

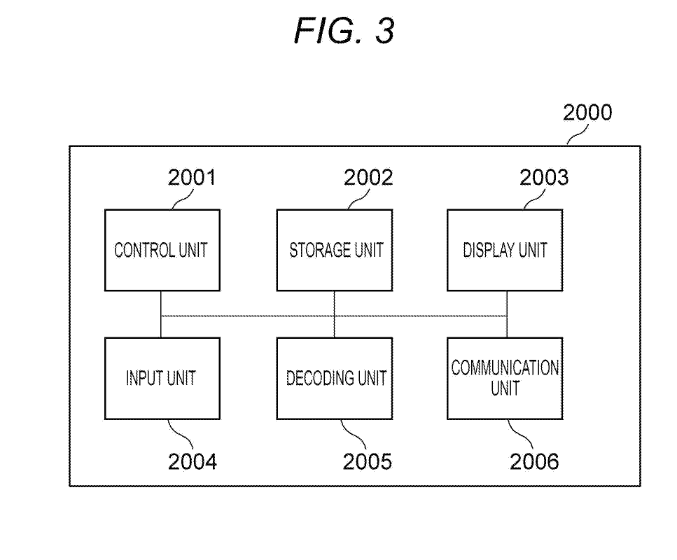

FIG. 3 is a diagram showing an internal configuration of the client device 2000.

In FIG. 3, reference numeral 2001 denotes a control unit. The control unit 2001 includes, for example, a CPU and controls the entire client device 2000.

Reference numeral 2002 denotes a storage unit. The storage unit 2002 is used as a storage area of various data, such as a storage area of a program executed by the control unit 2001 and a work area used when the program is being executed.

Reference numeral 2003 denotes a display unit. The display unit 2003 includes, for example, an LCD, an organic EL display, or the like and displays various setting screens including a delivery image setting screen, a viewer of a video received from the image capturing device 1000, and various messages to a user of the client device 2000.

Reference numeral 2004 denotes an input unit. The input unit 2004 includes, for example, a button, a cross key, a touch panel, and a mouse and transmits content of a screen operation performed by the user to the control unit 2001.

Reference numeral 2005 denotes a decoding unit. The decoding unit 2005 decodes an image data, which is received through a communication unit 2006 and which is compressed and encoded, based on a format of JPEG, H.264, or the like and spreads the decoded image data in the storage unit 2002.

Reference numeral 2006 denotes a communication unit. The communication unit 2006 is used when transmitting each control command to the image capturing device 1000 and when receiving a response to each control command and a video stream from the image capturing device 1000.

While the internal configurations of the image capturing device 1000 and the client device 2000 have been described with reference to FIGS. 2 and 3, the processing blocks shown in FIGS. 2 and 3 illustrate an example of a preferred embodiment of the image capturing device and the client device of the present invention, and the internal configurations of the image capturing device and the client device are not limited to those processing blocks. Various variations and modifications, such as a voice input unit and a voice output unit, are possible in the scope of the present invention.

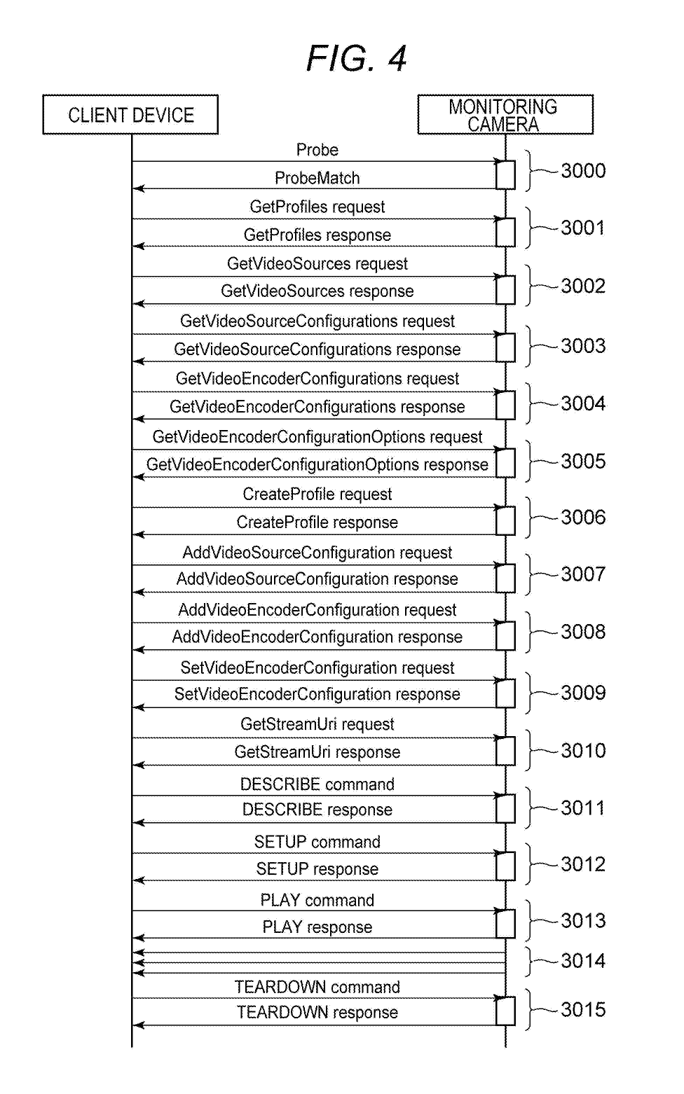

Next, a command transaction of the present embodiment will be described with reference to FIG. 4.

FIG. 4 shows a typical command sequence from start of setting to video streaming between the image capturing device 1000 and the client device 2000. Here, the transaction indicates a pair of a command transmitted from the client device 2000 to the image capturing device 1000 and a response returned from the image capturing device 1000 to the client device 2000.

Reference numeral 3000 denotes a transaction of apparatus search. The client device 2000 transmits a search request provided with a predetermined condition on a network. The image capturing device 1000 that matches the condition of the search request transmits a search response to the client device 2000.

Reference numeral 3001 denotes a transaction of acquisition of delivery profile. The client device 2000 identifies a deliverable delivery profile setting present in the image capturing device 1000 by a delivery profile ID and acquires a list of delivery profiles that can be currently used along with the delivery profile IDs.

Reference numeral 3002 denotes a transaction of image processing unit function acquisition. By this transaction, the client device 2000 acquires setting information of image processing function stored by the image capturing device 1000.

Reference numeral 3003 denotes a transaction of image processing setting list acquisition. By this transaction, the client device 2000 acquires a list including an ID of an image processing setting stored by the image capturing device 1000 from the image capturing device 1000.

Reference numeral 3004 denotes a transaction of compression encoding unit function acquisition. By this transaction, the client device 2000 acquires information related to a function provided by the compression encoding unit 1004 of the image capturing device 1000.

Reference numeral 3005 denotes a transaction of compression encoding setting list acquisition. By this transaction, the client device 2000 acquires a list including an ID of a compression encoding setting stored in the storage unit 1008 from the image capturing device 1000.

Reference numeral 3006 denotes a transaction of delivery profile creation request. By this transaction, the client device 2000 newly creates a delivery profile in the image capturing device 1000 and obtains an ID of the created delivery profile. The image capturing device 1000 stores the newly created delivery profile.

Reference numeral 3007 denotes a transaction of image processing setting addition request. By this transaction, the client device 2000 specifies the delivery profile ID acquired by the transaction 3006 and the ID of the image processing setting acquired by the transaction 3003. The image capturing device 1000 associates the specified image processing setting with the specified delivery profile and stores them.

Reference numeral 3008 denotes a transaction of compression encoding setting addition request. By this transaction, the client device 2000 specifies the delivery profile ID acquired by the transaction 3006 and the ID of the compression encoding setting acquired by the transaction 3005 and associates the compression encoding setting with the delivery profile. The image capturing device 1000 associates the specified compression encoding setting with the specified delivery profile and stores them.

Reference numeral 3009 denotes a transaction of compression encoding setting change. By this transaction, the client device 2000 changes content of the compression encoding setting acquired by the transaction 3004 based on an option acquired by the transaction 3005. For example, the client device 2000 changes a compression encoding method and a cutout size. The image capturing device 1000 stores content of the changed compression encoding setting.

Reference numeral 3010 denotes a transaction of delivery address acquisition request. In this transaction, the client device 2000 specifies the delivery profile ID acquired by the transaction 3006 and acquires a delivery address to acquire a video to be delivered based on the setting of the specified delivery profile. The image capturing device 1000 returns the image processing setting associated with the specified profile ID and the delivery address for an image corresponding to content of the compression encoding setting to be delivered to the client device 2000.

Reference numeral 3011 denotes a transaction of delivery information acquisition request. In this transaction, the client device 2000 specifies the delivery address acquired in the transaction 3010 and acquires detailed data related to delivery information of the image capturing device 1000.

Reference numeral 3012 denotes a transaction of delivery setting request. In this transaction, the client device 2000 causes the image capturing device 1000 to prepare for streaming based on the detailed data related to the delivery information acquired in the transaction 3011. By performing this command, a transmission method of a stream including a session number is shared between the client device 2000 and the image capturing device 1000.

Reference numeral 3013 denotes a transaction of delivery start. By using the session number acquired in the transaction 3012, the client device 2000 causes the image capturing device 1000 to start a steam of images based on the setting of the delivery profile specified in the image capturing device 1000.

Reference numeral 3014 denotes a stream delivered from the image capturing device 1000 to the client device 2000. The stream which is requested to be started in the transaction 3013 is delivered by the transmission method shared in the transaction 3012.

Reference numeral 3015 denotes a transaction of delivery stop. In this transaction, the client device 2000 specifies the session number acquired in the transaction 3012 and stops streaming that is being delivered.

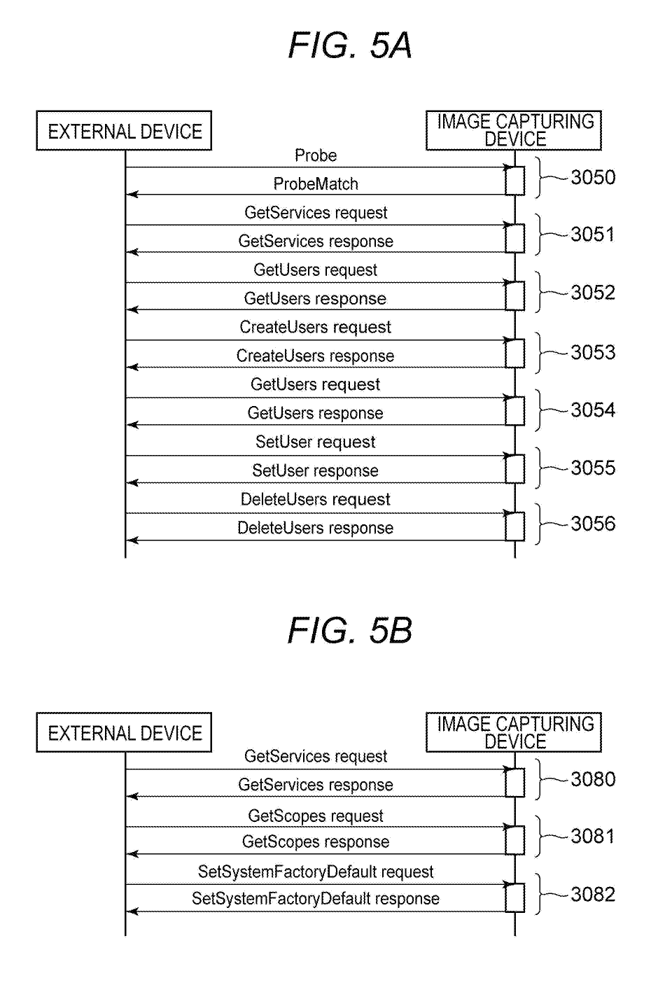

FIG. 5A shows a typical command sequence of creation/setting/deletion processing of a user between the image capturing device 1000 and the client device 2000.

Reference numeral 3050 denotes a transaction of apparatus search. The client device 2000 transmits a search request provided with a predetermined condition on a network. The image capturing device 1000 that matches the condition of the search request transmits a search response to the client device 2000.

Reference numeral 3051 denotes a transaction of function acquisition request. In this transaction, the client device 2000 acquires a list of functions held by the image capturing device 1000. The client device 2000 checks whether the image capturing device 1000 corresponds to creation/setting/deletion of a user.

Reference numeral 3052 denotes a transaction of user list acquisition request. By this transaction, the client device 2000 acquires a user list stored by the image capturing device 1000.

Reference numeral 3053 denotes a transaction of user creation request. In this transaction, the client device 2000 requests a creation of a desired user and the image capturing device 1000 creates the requested user and performs setting in the storage unit 1008.

Reference numeral 3054 denotes a transaction of user list acquisition request. By this transaction, the client device 2000 acquires a user list including the user that is created in the transaction 3053 and is stored by the image capturing device 1000.

Reference numeral 3055 denotes a transaction of user setting change request. By this transaction, the client device 2000 changes a desired user setting in the user list stored by the image capturing device 1000.

Reference numeral 3056 denotes a transaction of user deletion request. By this transaction, the client device 2000 deletes a user included in the user list acquired by the transactions 3052 and 3054 and the user that is newly created in the transaction 3053 from the image capturing device 1000. The image capturing device 1000 deletes information of a specified user.

Here, in the image capturing device 1000 of the present embodiment, it is also possible to operate the client device 2000 through the command sequence shown in FIG. 5A and set an authority level of a user who transmits a control command or the like. The image capturing device 1000 can limit executable control according to the authority level. The image capturing device 1000 of the present embodiment can set an administrator user. The administrator user is a user who is allowed to manage the entire image capturing device 1000 and is a user who has an authority level at which all the control commands can be performed. The image capturing device 1000 of the present embodiment stores an ID, an authority level, and a password of each user in association with each other in the storage unit 1008. Then, the image capturing device 1000 authenticates a user by an input result through the input unit 2004 and the like in the client device 2000 and sets an authority level stored in the storage unit 1008. The user authentication operation may be performed in the client device 2000 in the same manner, and a user authentication result of the client device 2000 may be diverted.

FIG. 5B shows a typical command sequence of the factory shipment settings between the image capturing device 1000 and the client device 2000.

Reference numeral 3080 denotes a transaction of function acquisition request. In this transaction, the client device 2000 checks whether the client device 2000 corresponds to the factory shipment settings.

Reference numeral 3081 denotes a transaction of apparatus state acquisition request. In this transaction, the client device 2000 checks a state of the image capturing device 1000. Here, the state of the image capturing device 1000 will be described later.

Reference numeral 3082 denotes a transaction of factory shipment setting corresponding function acquisition request. In this transaction, the client device 2000 checks whether an internal state of the image capturing device 1000 is changed when the image capturing device 1000 performs the factory shipment settings.

Reference numeral 3083 denotes a transaction of factory shipment setting request. By this transaction, the client device 2000 restores various setting information of the image capturing device 1000 to the factory shipment settings.

Here, the state of the image capturing device 1000 of the present embodiment includes at least a factory shipment state (hereinafter may be referred to as a FactoryDefault state) and a normal operation state (hereinafter may be referred to as an Operational state).

In the present embodiment, the FactoryDefault state includes a state in which no setting of administrator user is done or no setting of password of administrator user is done. Therefore, a user who operates the image capturing device 1000 can operate the image capturing device 1000 by using a control command regardless of the authority level. This state is used when various settings of the image capturing device 1000 are done before the image capturing device 1000 is installed and an operation is started or the like.

In the present embodiment, the Operational state is a state after the image capturing device 1000 is installed and an operation is started. In this state, a setting related to the administrator user is done. Therefore, the image capturing device 1000 performs an operation to limit an operation of control command according to the authority level of the user as usual.

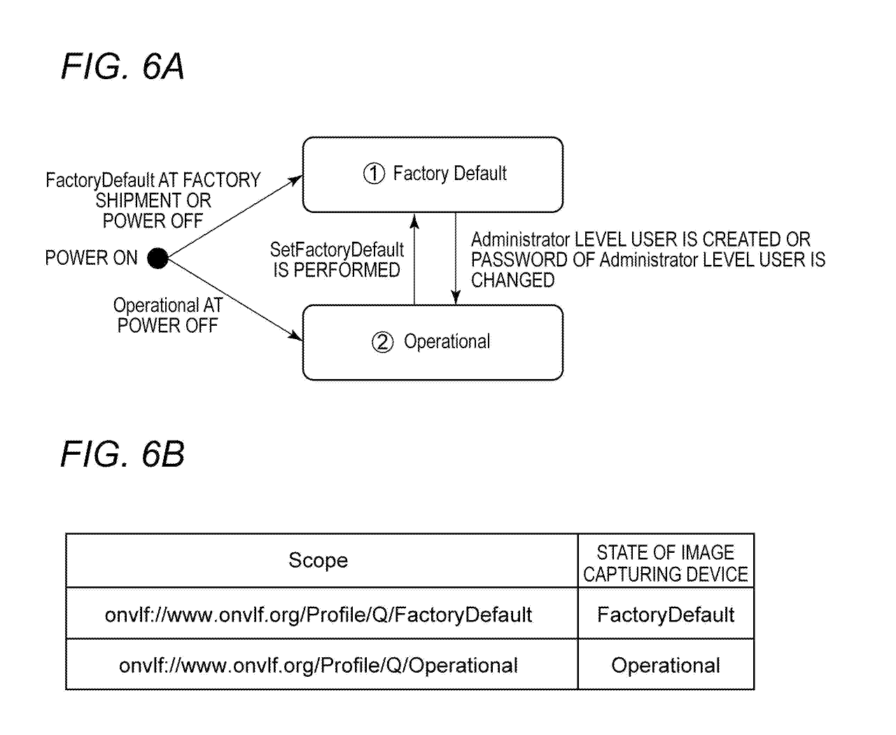

FIG. 6A is a definition example of a state of the image capturing device 1000 according to the present embodiment. The image capturing device 1000 of the present embodiment starts up in the FactoryDefault state if the image capturing device 1000 is immediately after factory shipment when the image capturing device 1000 is turned on or if the image capturing device 1000 was in the FactoryDefault state when the image capturing device 1000 was turned off the last time. Alternatively, the image capturing device 1000 starts up in the Operational state if the image capturing device 1000 was in the Operational state when the image capturing device 1000 was turned off the last time. When an administrator user is created from the client device 2000 by the user creation sequence shown in FIG. 5A in the FactoryDefault state, the image capturing device 1000 changes to the Operational state. When the administrator user is deleted by the factory shipment setting request shown in FIG. 5B in the Operational state, the image capturing device 1000 changes to the FactoryDefault state. Here, the state change is controlled by the control unit 1007. In other words, the control unit 1007 corresponds to a state control unit that controls the state of the image capturing device 1000.

FIG. 6B is a definition example of the state of the image capturing device 1000, which is acquired by the transaction 3081. When onvif://www.onvif.org/Profile/Q/FactoryDefault is included in information acquired by the transaction 3081, it is determined that the state of the image capturing device 1000 is the FactoryDefault state. When onvif://www.onvif.org/Profile/Q/Operational is included in information acquired by the transaction 3081, it is determined that the state of the image capturing device 1000 is the Operational state.

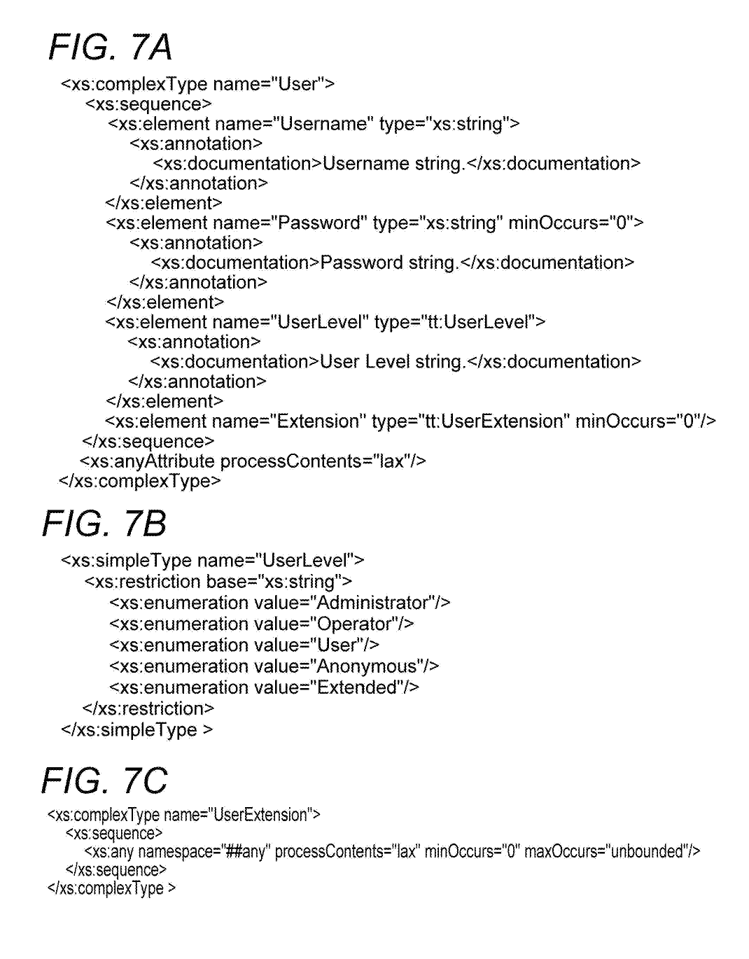

The data types shown in FIGS. 7A to 7C are defined by using an XML Schema Definition language (hereinafter may be referred to as XSD).

A definition example of User type which is a data type used in the transactions of the user list acquisition request, the user creation request, the user setting change request, and the user deletion request will be described with reference to FIGS. 7A to 7C.

FIG. 7A is a diagram showing a definition example of a User type. The User type is defined as a complex type by ComplexType declaration of XML. Regarding the User, it is shown that data expansion is performed so that the User appears sequentially as defined by the sequence element.

FIG. 7B is a diagram showing a definition example of UserLevel. It is shown that the UserLevel is a simple type of XML by the simpleType element and it is shown that the type is a value restriction type of a string type by a restriction element and its base attribute.

FIG. 7C is a diagram showing a definition example of a UserExtension type. The UserExtension type is defined as a complex type by ComplexType declaration of XML. Regarding the UserExtension type, it is shown that data expansion is performed so that the UserExtension type appears sequentially as defined by the sequence element.

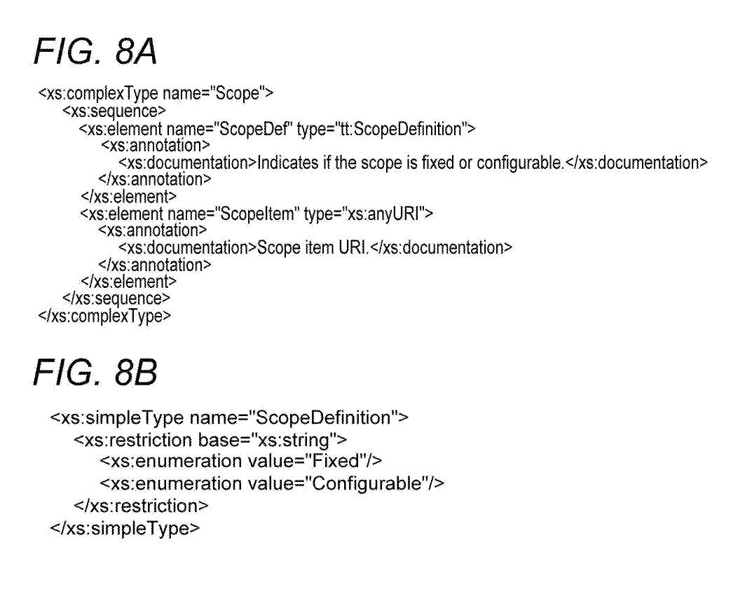

FIGS. 8A and 8B are diagrams for explaining a configuration of Scope which is a data type used in a transaction of apparatus search related to the present embodiment.

FIG. 8A is a diagram showing a definition example of the Scope. The Scope type is defined as a complex type by ComplexType declaration of XML. Regarding the Scope type, it is shown that data expansion is performed so that the Scope type appears sequentially as defined by the sequence element.

FIG. 8B is a diagram showing a definition example of ScopeDefinition. It is shown that the ScopeDefinition type is a simple type of XML by the simpleType element and it is shown that the type is a value restriction type of a string type by a restriction element and its base attribute.

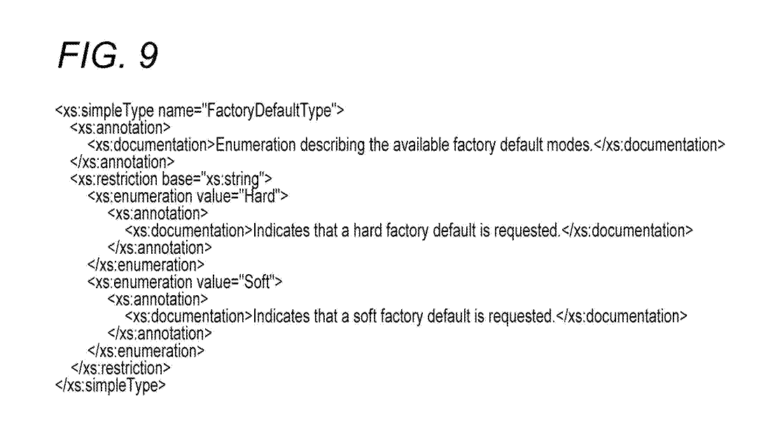

Next, a definition example of FactoryDefaultType type which is a data type used in the transaction of the factory shipment setting request will be described with reference to FIG. 9.

FIG. 9 is a diagram showing a definition example of the FactoryDefaultType type. It is shown that the FactoryDefaultType type is a simple type of XML by the simpleType element and it is shown that the type is a value restriction type of a string type by a restriction element and its base attribute. As content of the FactoryDefaultType according to the present embodiment, Hard and Soft are assumed.

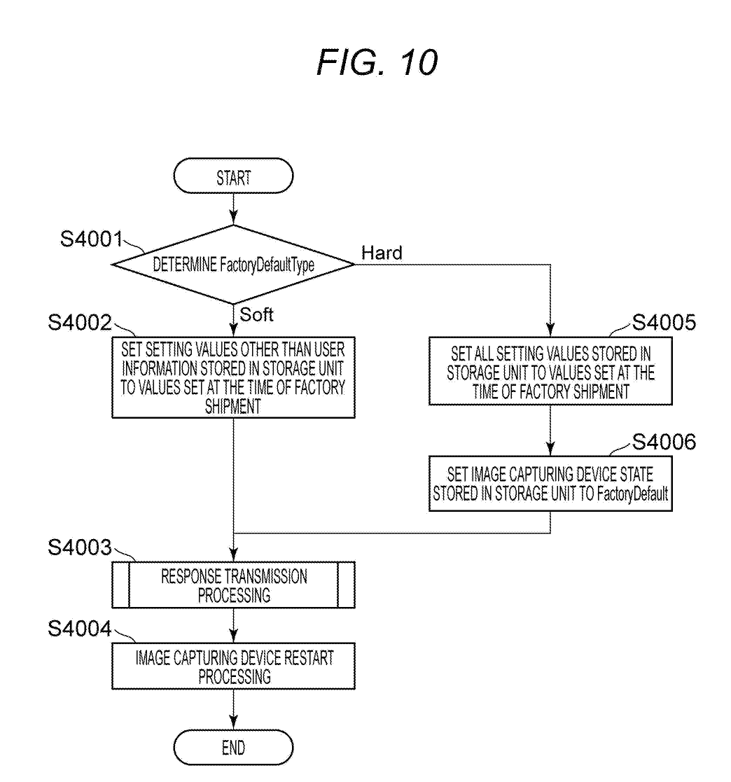

Next, reflection of the factory shipment settings by the setting information of SetFactoryDefault in a command which is the factory shipment setting request will be described in detail with reference to a flowchart in FIG. 10.

FIG. 10 shows processing of a case when the image capturing device 1000 receives the SetFactoryDefault command described above from the client device 2000. This processing is performed by the control unit 1007.

In step S4001, the control unit 1007 determines content of FactoryDefaultType input from the client device 2000. When the content of the FactoryDefaultType is Soft, the control unit 1007 advances the processing to step S4002. On the other hand, when the content of the FactoryDefaultType is Hard, the control unit 1007 advances the processing to step S4005.

In step S4002, the control unit 1007 updates the setting information other than the user information stored in the storage unit 1008 to values set at the time of factory shipment and thereafter advances the processing to step S4003.

In step S4003, the control unit 1007 performs response transmission processing where a response to the SetFactoryDefault command is returned to the client device 2000 and thereafter advances the processing to step S4004.

In step S4004, the control unit 1007 performs a restart of the image capturing device 1000. The control unit 1007 performs start processing and initialization processing based on the setting information in the storage unit 1008 which is set in step S4002 or step S4005 and then completes the processing.

In step S4005, the control unit 1007 updates all the setting information stored in the storage unit 1008 to values set at the time of factory shipment and thereafter advances the processing to step S4006.

In step S4006, the control unit 1007 sets the state of the image capturing device 1000 which is stored in the storage unit 1008 to the FactoryDefault and thereafter advances the processing to step S4003.

Here, the control unit 1007 analyzes content of the FactoryDefaultType and determines a range of the setting information to be initialized by using the analysis result. In other words, in the present embodiment, the control unit 1007 corresponds to an analysis unit that analyzes content of the control command and a determination unit that determines an initialization range.

In the present embodiment, the image capturing device 1000 changes a range of the setting information to be updated according to the content of the FactoryDefaultType. However, it is not limited to this. For example, a reset switch is provided to the image capturing device 1000 as an input unit and an operation to update all the setting information to the values set at the time of factory shipment may be performed by an input from the reset switch. Further, as content of the FactoryDefaultType, content other than the Soft and the Hard may be included. According to this content, the content of the setting information to be updated may be appropriately changed. Specifically, a range of the setting information to be updated may be specified by using an argument or the like.

The image capturing device 1000 is illustrated as an example of a communication device in the present embodiment. However, it is not limited to an image capturing device including an image capturing unit. When the present invention is used for an apparatus that communicates an image through a network, for example, when the present invention is used for a recording server or an image analysis server, the same effect can be obtained.

Whether or not to update user information when updating the setting information to values set at the time of factory shipment may be changed according to a state of the image capturing device 1000. Specifically, when the state of the image capturing device 1000 is the FactoryDefault, the user information may also be changed regardless of the content of FactoryDefaultType. In this case, the control unit 1007 detects the state of the image capturing device 1000, so that the control unit 1007 corresponds to a state detection unit that detects the state of the image capturing device 1000, and the control unit 1007 changes whether or not to also change the user information based on the detection result.

It is possible to enable a user to perform an appropriate device operation without forcing the user to perform complicated work by using a first update unit that updates all the setting information in the image capturing device 1000 to the values set at the time of factory shipment and a second update unit that updates at least a part of the setting information. Other Embodiments

It is possible to realize the present invention by supplying a program that realizes one or more functions of the embodiment described above to a system or a device through a network or a storage medium and causing one or more processors in a computer of the system or the device to read and execute the program. Further, it is also possible to realize the present invention by a circuit (for example, ASIC) that realizes one or more functions.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)m), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-017711, filed Jan. 30, 2015, which is hereby incorporated by reference herein in its entirety.

What is claimed is:

1. A communication device that includes a communication unit that communicates data with an external device through a network, the communication device comprising:
an authentication unit configured to perform user authentication in communication with the external device;
a storing unit configured to store setting information including an account setting used for the authentication unit; and
an initialization unit configured to update the setting information stored in the storing unit to initial values,
wherein the initialization unit includes a first initialization unit configured to update a predetermined range of the setting information to initial values and a second initialization unit configured to update a larger range of the setting information than the range updated by the first initialization unit to initial values, and
the second initialization unit updates at least the account setting included in the setting information to an initial value and the first initialization unit does not update the account setting included in the setting information to the initial value.

2. The communication device according to claim 1, further comprising:
a receiving unit configured to receive a control command for setting the setting information,
wherein the control command includes an initialization command for controlling the first initialization unit.

3. The communication device according to claim 2, further comprising:
a setting unit configured to set the setting information,
wherein the state control unit controls so that a state transits to the second state when the account setting related to the administrator user is set by the setting unit.

4. The communication device according to claim 1, further comprising: an initialization instruction unit configured to send an instruction to operate the second initialization unit.

5. The communication device according to claim 1, further comprising:
a receiving unit configured to receive a control command for setting the setting information;
an analysis unit configured to analyze whether an initialization command included in the control command received by the receiving unit is a command for controlling the first initialization unit or a command for controlling the second initialization unit; and
a determination unit configured to determine whether to control the first initialization unit or the second initialization unit based on an analysis result of the analysis unit.

6. The communication device according to claim 1, further comprising:
a state control unit configured to control transition to a first state indicating at least an initial state,
wherein the state control unit transitions a state to the first state when the setting information is updated to initial values by the second initialization unit and does not transition a state to the first state when the setting information is updated to initial values by the first initialization unit.

7. The communication device according to claim 1, further comprising:
a state determination unit configured to determine whether a state of the communication device is a first state indicating an initial state or a second state indicating an operating state; and
a control unit configured to control the first initialization unit and the second initialization unit,
wherein the control unit controls either one of the first initialization unit and the second initialization unit based on a determination result of the state determination unit.

8. The communication device according to claim 7, wherein the state control unit further controls transition to a second state indicating an operating state.

9. The communication device according to claim 8, further comprising: a restriction unit configured to restrict usable functions based on an authentication result of the authentication unit.

10. The communication device according to claim 9, wherein the restriction unit restricts the functions based on the authentication result of the authentication unit when a state is transited to the second state by the state control unit and alleviates restriction of functions when a state is transited to the first state by the state control unit.

11. The communication device according to claim 1, wherein an account setting related to an administrator user is included in account settings that are not updated by the first initialization unit.

12. The communication device according to claim 1, further comprising:
an image capturing unit configured to capture an image including a subject, and
a generation unit configured to generate image data from the image captured by the image capturing unit,
wherein the data communicated with the external device through the network includes the image data generated by the generation unit.

13. A communication device that includes a communication unit that communicates data with an external device through a network, the communication device comprising:
an authentication unit configured to perform user authentication in communication with the external device;
a storing unit configured to store setting information including an account setting used for the authentication unit;
an initialization unit configured to update the setting information stored in the storing unit to initial values; and
a state control unit configured to control a state based on a range of setting information that is updated to initial values by the initialization unit,
wherein the initialization unit includes a first initialization unit configured to update a predetermined range of the setting information to initial values and a second initialization unit configured to update the setting information further including an account setting in addition to the range, which is updated by the first initialization unit, to initial values,
the state includes at least an initialization state, and
the state control unit controls the state to the initialization state when the second initialization unit updates the setting information and does not control the state to the initialization state when the first initialization unit updates the setting information.

14. The communication device according to claim 13, wherein the state includes an operating state.

15. The communication device according to claim 14, further comprising: a restriction unit configured to restrict usable functions based on an authentication result of the authentication unit.

16. The communication device according to claim 15, wherein the restriction unit restricts the functions based on the authentication result of the authentication unit when the state control unit controls the state to the operating state and alleviates restriction of functions when the state control unit controls the state to the initialization state.

17. A communication system comprising: a communication device including a communication unit that communicates data with an external device through a network,
wherein the external device includes
a transmission unit configured to transmit a control command for controlling the communication device,
the communication device includes
an authentication unit configured to perform user authentication in communication with the external device based on the control command,
a storing unit configured to store setting information including an account setting used for the authentication unit, and
an initialization unit configured to update the setting information stored in the storing unit to initial values,
the initialization unit includes a first initialization unit configured to update a predetermined range of the setting information to initial values and a second initialization unit configured to update a larger range of the setting information than the range updated by the first initialization unit to initial values, and
the second initialization unit updates at least the account setting included in the setting information to an initial value and the first initialization unit does not update the account setting included in the setting information to the initial value.
